(19) United States
(12) Patent Application Publication
(10) Pub. No.: US 2002/0177677 A1
(43) Pub. Date: Nov. 28, 2002

(54) Ethylene polymer and resin composition for producing cast film, and process for producing cast film

(75) Inventors: Kazunori Kanamori, Ichihara-shi (JP); Kenzo Chikanari, Ichihara-shi (JP); Tatsuhiro Nagamatsu, Ichihara-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/108,444

(22) Filed: Mar. 29, 2002

Related U.S. Application Data
(62) Division of application No. 09/626,457, filed on Jul. 26, 2000, now abandoned.

(30) Foreign Application Priority Data
Jul. 30, 1999 (JP) 11-217582

(51) Int. Cl. C08F 110/14

(52) U.S. Cl. 526/170; 525/240; 526/943; 526/348.5; 526/348.6

(57) ABSTRACT

Ethylene polymer for cast film processing at about 210 to 350° C. having a slip velocity at metal wall of not less than about 30 mm/sec, wherein polymer is obtained by polymerization using a metallocene catalyst; a resin composition for cast film processing at about 210 to 350° C., which composition comprises:

(i) from about 40 to about 90% by weight of ethylene polymer obtained by polymerization using a metallocene catalyst for olefin polymerization; and

(ii) from about 60 to about 10% by weight of polyolefine based resin;

and which composition has a slip velocity at a metal wall of not less than about 30 mm/sec; and processes for producing cast film from the ethylene polymer or from the resin composition.

### FIELD OF THE INVENTION

The present invention relates to an ethylene polymer and a resin composition for producing a cast film, and relates to a process for producing a cast film. More specifically, the present invention relates to an ethylene polymer and a resin composition for producing a cast film, which film hardly has a die-line and/or a gel thereon, and relates to a process for producing a cast film, which process hardly produce a die lip buildup and/or an adhering matter inside a die, even when producing the cast film at a high speed.

In the present invention, the term, “die lip buildup”, means an undesirable material accumulated around a die lip, and the term, “die-line”, means an undesirable streaky pattern formed on a film due to a die lip buildup and/or an adhering matter inside a die.

### BACKGROUND OF THE INVENTION

There is known a process for producing a film using an ethylene polymer according to cast film processing, which polymer is obtained by polymerizing an olefin using a metallocene catalyst, and has a narrow molecular weight distribution.

However, it has been found that (i) the above-mentioned process produces lots of die lip buildups , and (ii) the film obtained according to said process has lots of die-lines and gels thereon, when producing the film from the above-mentioned ethylene polymer at a temperature exceeding 200° C., in order to increase productivity of the film, in other words, in order to carry out the cast film processing at a high speed.

### SUMMARY OF THE INVENTION

An object of the present invention is to provide an ethylene polymer and a resin composition for producing a cast film, and a process for producing a cast film, which are capable of diminishing remarkably the problems mentioned above.

The present inventors have undertaken extensive studies about a film processing free from the foregoing problems, even when producing a cast film at a temperature exceeding 200° C. using an ethylene polymer obtained by polymerizing an olefin using a metallocene catalyst. As a result, it has been found that a specific ethylene polymer obtained by polymerization using a metallocene catalyst for olefin polymerization, and a specific composition comprising an ethylene polymer obtained by polymerization using a metallocene catalyst for olefin polymerization and a polyolefin based resin can be used to solve the foregoing problems, and thereby the present invention has been obtained.

The present invention provides an ethylene polymer for cast film processing at a temperature of from about 210 to about 350° C., which polymer has a slip velocity at a metal wall of not less than about 30 mm/sec, wherein the ethylene polymer is obtained by polymerization using a metallocene catalyst for olefin polymerization, and the slip velocity is measured at a temperature of 240° C. and a shear rate of 500 sec⁻¹.

Further, the present invention provides a resin composition for cast film processing at a temperature of from about 210 to about 350° C., which composition comprises:

(i) from about 40 to about 90% by weight of an ethylene polymer obtained by polymerization using a metallocene catalyst for olefine polymerization; and

(ii) from about 60 to about 10% by weight of a polyolefine based resin;

and which composition has a slip velocity at a metal wall of not less than about 30 mm/sec;

provided that the sum of the ethylene polymer and the polyolefin based resin is 100% by weight.

Still further, the present invention provides a process for producing a cast film, which comprises the step of cast film processing, at a temperature of from about 210 to about 350° C., an ethylene polymer having a slip velocity at a metal wall of not less than about 30 mm/sec, wherein the ethylene polymer is obtained by polymerization using a metallocene catalyst for olefin polymerization, and the slip velocity is measured at a temperature of 240° C. and a shear rate of 500 sec⁻¹.

Additionally, the present invention provide a process for producing a cast film, which comprises the step of cast film processing, at a temperature of from about 210 to about 350° C., a resin composition having a slip velocity at a metal wall of not less than about 30 mm/sec, wherein the resin composition comprises:

(i) from about 40 to about 90% by weight of an ethylene polymer obtained by polymerization using a metallocene catalyst for olefine polymerization; and

(ii) from about 60 to about 10% by weight of a polyolefine based resin; and

the slip velocity is measured at a temperature of 240% and a shear rate of 500 sec⁻¹;

provided that the sum of the ethylene polymer and the polyolefin based resin is 100% by weight.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 shows a relationship between a shear rate and a shearing stress with respect to the polymer PE-\mathring{1} used in Example 1. Secondary regression curves of the orifices-A and -B are expressed by the following equations, respectively.

Orifice-A: log(τ)=−0.1296(log(γ))²+1.1601(log(τ))−2.7820

Orifice-B: log(τ)=−0.1330(log(γ))²+1.1743(log(γ))−2.7133

FIG. 2 shows a relationship between a reciprocal number of an orifice diameter and a shear rate, which was obtained based on FIG. 1.

FIG. 3 shows a relationship between a shear rate and a slip velocity, which was obtained based on FIG. 2.

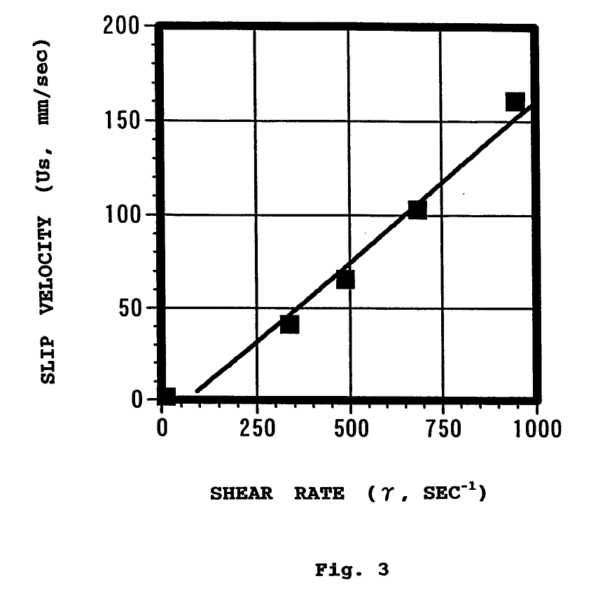

### DETAILED DESCRIPTION OF THE INVENTION

The term, “metallocene catalyst for olefin polymerization” means a catalyst, which is obtained using a transition metal compound having a cyclopentadiene based anion skeleton-carrying group, which compound is referred to hereinafter as “metallocene type transition metal compound”. Preferred metallocene type transition metal compounds are those represented by the following formula (1),

MLₐXₙ₋ₐ (1)

wherein M is a transition metal atom belonging to the 4 group or the lanthanide group of elements in the periodic table of the elements; L is a cyclopentadiene based anion skeleton-carrying group or a hetero atom-containing group, provided that at least one L is the cyclopentadiene based anion skeleton-carrying group, and when L is plural, those L's may be cross-linked with one another; X is a halogen atom, a hydrogen atom or a hydrocarbon group having 1 to 20 carbon atoms; n is a valence of the transition metal M; and a is an integer satisfying 0<a≦n .

Examples of the metallocene type transition metal compound are bis(1,3-n-butylmethylcyclopentadienyl)zirconium dichloride, bis(1,3-n-propylmethylcyclopentadienyl)zirconium dichloride, bis(n-butylcyclopentadienyl)zirconium dichloride, bis(1,3-dimethylcyclopentadienyl)zirconium dichloride, bis(1,3-diethylcyclopentadienyl)zirconium dichloride, ethylene-bis(indenyl)zirconium dichloride, ethylene-bis(4-methyl-1-indenyl)zirconium dichloride, and ethylene-bis(4,5,6,7-tetrahydro-1-indenyl)zirconium dichloride.

It is preferable to contact the metallocene type transition metal compound with a cocatalyst before use thereof. Examples of the cocatalyst are an alumoxane compound, and a combination of a boron compound such as trityl borate and anilinium borate with an organoaluminum compound.

Each of the metallocene type transition metal compound, the cocatalyst and the contact product of the metallocene type transition metal with the cocatalyst may be supported on an inorganic carrier such as SiO₂ and Al₂O₃, or on an organic polymer carrier such as an ethylene polymer and a styrene polymer.

The term, “slip velocity at a metal wall”, used in the present invention means a value, which is obtained by measurement according to Mooney's method described in Mooney M. J., Rheol., 2, 210 (1931). The slip velocity of the ethylene polymer or the resin composition in accordance with the present invention is not less than about 30 mm/sec, preferably not less than about 35 mm/sec, more preferably not less than about 40 mm/sec, and much more preferably not less than about 50 mm/sec.

The term, “ethylene polymer”, in accordance with the present invention means a polymer having a crystal structure of polyethylene, and contains an ethylene homopolymer and a copolymer of ethylene with a different comonomer. As the different comonomer, an α-olefin and a diolefin having 3 to 20 carbon atoms are preferred. Examples of the α-olefin and diolefin are propylene, butene-1, pentene-1, hexene-1, heptene-1, octene-1, nonene-1, decene-1, hexadecene-1, eicosene-1, 4-methylpentene-1, 4-methylhexene-1, vinylcyclohexane, vinylcyclohexene, styrene, norbornene, butadiene and isoprene. These comonomers may be used singly or in combination of two or more. An amount of the comonomer copolymerized is usually from about 2 to about 70% by weight, provided that a sum of an amount of ethylene copolymerized and an amount of the comonomer copolymerized is assigned to be 100% by weight.

A ratio of a weight average molecular weight (Mw) to a number average molecular weight (Mn), Mw/Mn, of the ethylene polymer and the resin composition in accordance with the present invention is preferably not less than about 3.0, more preferably from about 3.0 to about 10.0, and much more preferably from about 3.0 to about 7.0, from a viewpoint of hardly producing any die lip buildup and obtaining a film hardly having any die-line and/or gel. The ratio, Mw/Mn, mentioned above is a value obtained by measurement at 140° C. in a conventional manner using a gel permeation chromatograph-measuring apparatus with an o-dichlorobenzene mobile phase.

As the ethylene polymer in accordance with the present invention, the following ethylene polymers are preferred from a viewpoint of hardly producing any die lip buildup, and obtaining a film hardly having any die-line and/or gel.

(1) One kind of ethylene polymer, which is produced by a catalyst (a composite catalyst) prepared by using at least two kinds of the metallocene type transition metal compound.

(2) An ethylene polymer, which comprises a combination of at least two kinds of ethylene polymers produced by a catalyst prepared by using one kind of the metallocene type transition metal compound.

(3) An ethylene polymer, which comprises a combination of at least two kinds of ethylene polymers produced by a catalyst (a composite catalyst) prepared by using at least two kinds of the metallocene type transition metal compound.

(4) An ethylene polymer, which comprises a combination of (i) the ethylene polymer produced by a catalyst (a composite catalyst) prepared by using at least two kinds of the metallocene type transition metal compound, and (ii) the ethylene polymer produced by a catalyst prepared by using one kind of the metallocene type transition metal compound.

(5) An ethylene polymer, which is produced continuously in plural polymerization vessels by a catalyst prepared by using at least one metallocene type transition metal compound, wherein polymerization conditions are different from one another (multi-step polymerization polymer).

The resin composition in accordance with the present invention comprises (i) from about 40 to about 90% by weight of an ethylene polymer obtained by polymerization using a metallocene catalyst for olefine polymerization, and (ii) from about 60 to about 10% by weight of a polyolefine based resin, provided that the sum of the ethylene polymer and the polyolefin based resin is 100% by weight. Preferable resin compositions are those satisfying the following formula (2) or (3), and more preferably those satisfying the formula (2), from a viewpoint of obtaining a film having superior physical properties such as strength and an anti-blocking property, and hardly having any die-line and/or gel with hardly producing any die lip buildup:

MFR\mathring{2}>4×MFR\mathring{1} (2)

MFR\mathring{2}<MFR\mathring{1}/4 (3)

wherein MFR \mathring{1} is an MFR of the ethylene polymer, and MFR \mathring{2} is an MFR of the polyolefin based resin, provided that the term, “MFR”, means a melt flow rate obtained by measurement at a temperature of 190% and a load of 2.16 kg according to JIS K6760.

The ethylene polymer, which is one of the constituents contained in the resin composition in accordance with the present invention, may have a wide or narrow molecular weight distribution. The ethylene polymer may have both a narrow molecular weight distribution and a narrow comonomer distribution, which polymer is obtained by polymerization by a catalyst prepared using one kind of methalocene type transitional metal compound.

Examples of the polyolefin based resin used in the present invention are an ethylene polymer other than that obtained by polymerization by a-catalyst prepared using the metallocene catalyst for olefin polymerization, in other words, an ethylene polymer other than that in accordance with the present invention, the former ethylene polymer being referred to hereinafter as “non-metallocene ethylene polymer”; a propylene homopolymer; a copolymer of ethylene with propylene; a copolymer of at least one α-olefin having 4 to 20 carbon atoms with propylene; a copolymer of ethylene with at least one α-olefin having 4 to 20 carbon atoms and propylene; a copolymer of at least one diolefin having 4 to 20 carbon atoms with propylene; and a copolymer of ethylene with at least one diolefin having 4 to 20 carbon atoms and propylene. Of these, preferred is the non-metallocene ethylene polymer, among which linear low density polyethylene is preferable, which polyethylene is produced using a solid titanium catalyst having a titanium atom, a magnesium atom and a halogen atom.

How to produce the resin composition in accordance with the present invention is not particularly limited. Examples of a process for producing same are:

(1) a process comprising the step of melt-kneading the ethylene polymer and the polyolefin based resin, and

(2) a process comprising the step of homopolymerizing ethylene or copolymerizing ethylene with a different comonomer using a combination of the metallocene catalyst for olefin polymerization and the solid titanium catalyst mentioned above.

In the above-mentioned process (2), both catalysts may be used at the same time, or one after another so as to carry out the polymerization stepwise.

According to the present invention, a film hardly having any die-line and/or gel can be produced by cast film processing the foregoing ethylene polymer or the resin composition at about 210 to about 350° C. (a temperature of the cast film processing) with a high productivity with hardly producing any die lip buildup. The cast film obtained has gels of preferably not more than about 140/m² in its number. When the temperature of cast film processing is fixed to about 240° C. or higher, the processing can be carried out at a higher speed, and when it is fixed to about 260° C. or higher, the processing can be carried out at a much higher speed. The temperature of cast film processing may be determined appropriately depending on thermal properties of the ethylene polymer or the resin composition used. Here, the temperature of cast film processing is that measured by a thermocouple thermometer.

A cast film processing apparatus used in the present invention is not particularly limited. As examples thereof, a conventional cast film processing apparatus and a conventional extrusion lamination processing apparatus are enumerated. When producing a co-extruded multi-layer film, it is preferable for an outmost layer thereof to comprise the ethylene polymer or the resin composition in accordance with the present invention, from a viewpoint of producing a film hardly having any die-line and/or gel with hardly producing any die lip buildup.

So long as physical properties of the film obtained are not impaired, the ethylene polymer or the resin composition may be used in combination with a processing improver such as a metal salt of a fatty acid (for example, calcium stearate), a fluorocarbon resin and a polysiloxane, from a viewpoint of producing the film hardly having any die-line and/or gel thereon with hardly producing any die lip buildup.

Further, if desired, the ethylene polymer or the resin composition in accordance with the present invention may be used in combination with a phenol based stabilizer such as 2,6-di-t-butyl-p-cresol (SUMILIZER BHT, a trademark of Sumitomo Chemical Co., Ltd.), tetraxis[methylene-3-(3,5-di-t-butyl-4-hydroxyphenyl) propionate] methane (IRGANOX 1010, a trademark of Ciba Specialty Chemicals K.K.) and n-octadecyl-3-(4′-hydroxy-3,5′-di-t-butylphenyl) propionate (IRGANOX 1076, a trademark of Ciba Specialty Chemicals K.K.); a phosphite based stabilizer such as bis(2,4-di-t-butylphenyl) pentaerythritoldiphosphite and tris(2,4-di-t-butylphenyl)phosphite; a lubricant such as a higher fatty acid amide and a higher fatty acid ester; an antistatic agent such as a glycerin ester of a fatty acid having 8 to 22 carbon atoms, a sorbitan acid ester and a polyethylene glycol ester; and an anti-blocking agent such as silica, calcium carbonate and talc.

How to mix the ethylene polymer or the resin composition with the above-mentioned additives such as a processing improver, a stabilizer, a lubricant, an antistatic agent and an anti-blocking agent is not limited. As examples of said mixing processes, (1) a process comprising the step of melt-kneading the present ethylene polymer or the resin composition with said additives, (2) a process comprising the step of dry-blending the present ethylene polymer or the resin composition with said additives, and (3) a process comprising the step of dry-blending the present ethylene polymer or resin composition with a master batch of said additives, are enumerated.

The cast film obtained in accordance with the present invention can be used by itself, or can be used as a film laminated on a substrate such as cellophane, paper, fabrics, board paper, aluminum foil, polyamide resins (for example, nylon 6 and nylon 66), polyester resins (for example, polyethylene terephthalate and polybutylene terephthalate), and stretched polypropylene.

### EXAMPLE

The present invention is illustrated in more detail with reference to the following Examples, which are only illustrative, and are not limitative for the scope of the present invention.

1. Polymers used in Examples and Comparative Example

PE-\mathring{1}: Ethylene/hexene-1 copolymer (a content of a structural unit derived from hexene-1 in the copolymer=11.9% by weight), a trademark of SUMIKATHENE E KT3002, manufactured by Sumitomo Chemical Co., Ltd., using a metallocene catalyst for olefin polymerization, density=912 kg/m³, MFR=2.2 g/10 min., Mw/Mn=3.4, and slip velocity at a metal wall=76 mm/sec.

PE-\mathring{2}: Ethylene/hexene-1 copolymer (a content of a structural unit derived from hexene-1 in the copolymer=12.1% by weight), a trademark of SUMIKATHENE E FV203, manufactured by Sumitomo Chemical Co., Ltd., using a metallocene catalyst for olefin polymerization, density=912 kg/m³, MFR=2.0 g/10 min., Mw/Mn=2.4, and slip velocity at a metal wall=26 mm/sec.

PE-\mathring{3}: Ethylene/butene-1 copolymer (content of a structural unit derived from butene-1 in the copolymer=2.2% by weight), a trademark of SUMIKATHENE L GA804, manufactured by Sumitomo Chemical Co., Ltd., using a solid titanium catalyst, density=930 kg/m³, and MFR=50 g/10 min.

PE-\mathring{4}: Ethylene/butene-1 copolymer (content of a structural unit derived from butene-1 in the copolymer=6.9% by weight), a trademark of SUMIKATHENE L FS240A, manufactured by Sumitomo Chemical Co., Ltd., using a solid titanium catalyst, density=919 kg/m³, and MFR=2.0 g/10 min.

2. Evaluation method

(1) Temperature of Cast Film Processing

Measured using a thermocouple thermometer.

(2) Melt Flow Rate (MFR)

Measured at a temperature of 190° C. and a load of 2.16 kg according to a method prescribed in JIS K6760.

(3) Density

Measured according to a method prescribed in JIS K6760.

(4) slip Velocity at Metal Wall

Measured according to a Mooney's method described in Mooney M., Rheol., 2, 210 (1931), which method consists of the following steps:

Step-1: An orifice-A of 20 mm length, 1 mm diameter, 90° inflow angle and 0.1 μm maximum surface roughness is attached to the lower part of a barrel of 9.55 mm diameter and 350 mm length, which barrel is equipped to capillary rheometer manufactured by Toyo Seiki Seisaku-Sho, Ltd., and thereafter the barrel is heated to 240%.

Step-2: A sample is placed and melted in the barrel, and then a piston speed is raised to 0.5, 1, 2, 5, 10, 20, 50, 100, 200 and 500 mm/min. in this order, and the sample melted is extruded through the orifice at each piston speed. A shear rate and a shearing stress bearing to the orifice at each piston speed are measured.

Step-3: The orifice-A is changed to an orifice-B of 20 mm length, 2 mm diameter, 900 inflow angle and 0.1 m maximum surface roughness, and after heating the barrel to 240° C., Step-2 is repeated.

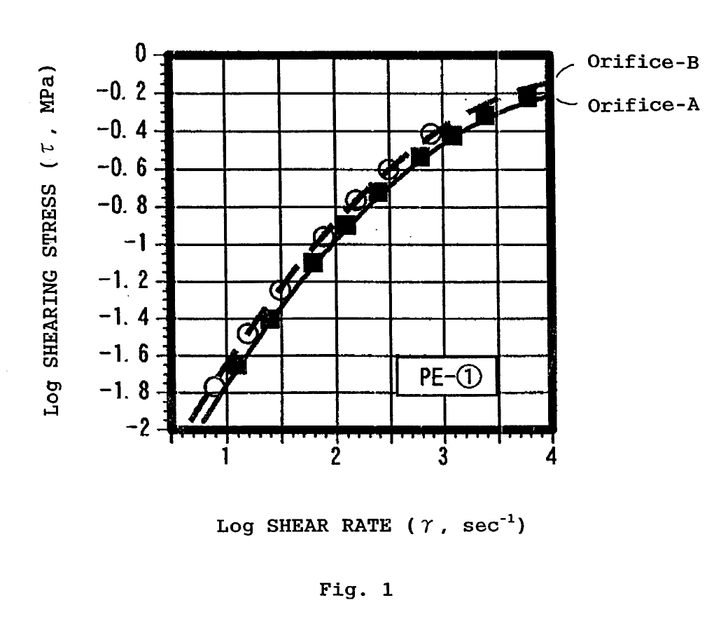

Step-4: With respect to the orifices-A and -B, a logarithm of the shear rate (horizontal axis) and that of the shearing stress (vertical axis) are plotted, and thereafter, a secondary regression curve is obtained through regression by least-squares method. From the secondary regression curve obtained, respective shear rates corresponding to the shearing stress of 0.25, 0.30 and 0.35 MPa (if possible, 0.40 MPa, too) are found out. Refer to FIG. 1.

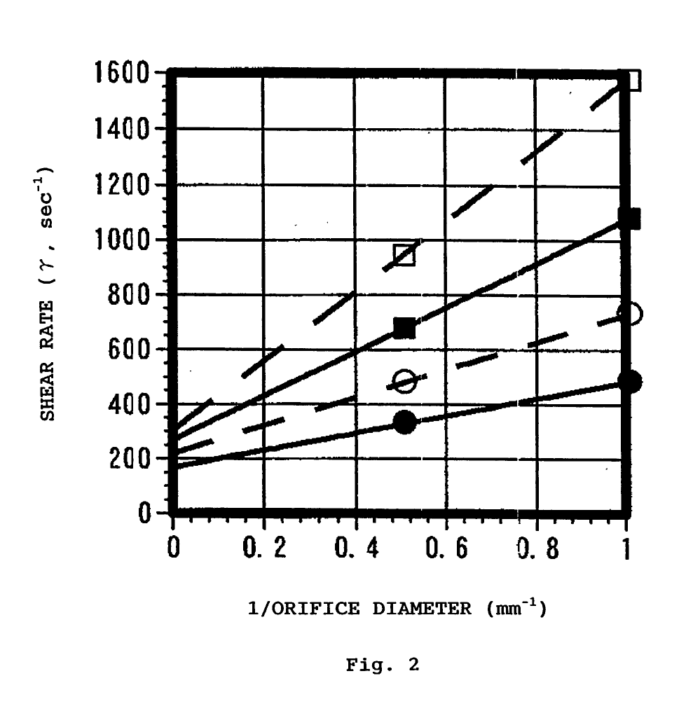

Step-5: Reciprocal number of the orifice diameter (horizontal axis) and the shear rate (vertical axis) obtained in Step-4 are plotted, and a linear line is drawn to link two points in respective shearing stresses in Step-4. Then, inclination of said linear line is measured. Refer to FIG. 2, and

Step-6: The shear rate (horizontal axis), corresponding to the shearing stress with respect to the orifice-B, which is obtained in Step-4, and a value (slip velocity, Us, vertical axis) corresponding to one eight of the above-mentioned inclination are plotted, and then a regression curve is obtained through regression by least-squares method. Using said regression curve, a value of the slip velocity (vertical axis) corresponding to the shear rate (horizontal axis) of 500 sec⁻¹ is assigned to be the slip velocity at a metal wall.

(5) Die Lip Buildup

The die lip buildup in the production of the film was visually evaluated on the following criteria.

No die lip buildup was observed: ∘

Die lip buildup was slightly observed: Δ

Die lip buildup was largely observed: ×

Die lip buildup was remarkably observed: ××

(6) Die-Line

The die-line of the film obtained was visually evaluated on the following criteria.

No die-line was observed: ⊚

Shallow die-line was observed to some extent: ∘

Shallow die-line was observed in large quantities: Δ

Deep die-line was observed to some extent: ×Deep die-line was observed in large quantities: ××

(7) Gel

Numbers of gels per 1 m² of the film obtained were visually counted.

(8) Weight Average Molecular Weight (Mw) and Number Average Molecular Weight (Mn)

Measured according to gel permeation chromatography (GPC). GPC measuring conditions were as follows.

A mixture of 5 mg of a sample and 5 ml of o-dichlorobenzene was heated at 140° C. for 2 hours to obtain a solution. The solution obtained was filtered with a 0.5 μm filter, and the resulting filtrate was analyzed according to gel permeation chromatography (GPC) to find out the weight average molecular weight (Mw) and the number average molecular weight (Mn). Conditions for GPC were as follows.

| | |
|---|---|
| Apparatus | 150C ALC/GPC, manufactured by Waters |
| | Co., Ltd. |
| Column | Shodex At-806M/S, 8 mm φ × 250 mm (two |
| | columns) |
| Temperature | 140° C. |
| Mobile phase | o-dichlorobenzene (1.0 ml/min.) |
| Detector | differential refraction |
| Amount injected | 400 μl |

### EXAMPLE 1

PE-\mathring{1} was extruded under conditions of a temperature of 220° C. and an output of 9.5 kg/hr using a 40 mm extruder, manufactured by Tanabe Plastics Machinery Co, Ltd., whose tip was equipped with a slit die of slit width=37 mm, slit gap=1.5 mm and land length=10 mm, thereby obtaining a cast film. At a 2 hour lapse of time after starting the extrusion, a die lip buildup was slightly observed at the die outlet.

Further, a three layer film of 2-kind, 3-layer structure having both outer layers of PE-\mathring{1} and an inner layer of PE-\mathring{4} was obtained. Here, the film formation was carried out using a 50 mm extruder for the formation of the inner layer, a 40 mm extruder for the formation of both outer layers, and a feed-block type T-die of die width=600 mm, lip gap=0.3 mm and temperature=300° C. under conditions of a resin temperature of 260 to 280° C. (tip portion of the extruder) and a total output of 40 kg/hr. At a 2 hour lapse of time after starting the extrusion, no die-line was observed.

Still further, a single layer film of 1-kind, 3-layer structure consisting of PE-\mathring{1} only was obtained. Here, the film formation was carried out using a 90 mm extruder for the formation of the inner layer, a 65 mm extruder for the formation of both outer layers, and a feed-block type T-die of die width=1250 mm, lip gap=1.7 mm and temperature=250° C. under conditions of a resin temperature of 240 to 260° C. (tip portion of the extruder) and a total output of 320 kg/hr. At a 45 minute lapse of time after starting the extrusion, 74 gels per m² were observed. The results are shown in Table 1.

### COMPARATIVE EXAMPLE 1

Example 1 was repeated, except that PE-\mathring{2} was used in place of PE-\mathring{1} to obtain a cast film, a three layer film of 2-kind, 3-layer structure and a single layer film of 1-kind, 3-layer structure. At a 2 hour lapse of time after starting the extrusion of the cast film, die lip buildups were remarkably observed at the die outlet. The three layer film of 2-kind, 3-layer structure had a deep die-line thereon in large quantities, and the single layer film of 1-kind, 3-layer structure had 164 gels per m2 thereon. The results are shown in Table 1.

### EXAMPLE 2

Example 1 was repeated, except that a resin composition comprising 80% by weight of PE-\mathring{2} and 20% by weight of PE-\mathring{3}, and having a slip velocity at metal wall=50 mm/sec. and Mw/Mn=3.6, was used in place of PE-\mathring{1}, thereby obtaining a multi-layer film of 2-kind, 3-layer structure. Said film had shallow die-lines in large quantities. The results are shown in Table 1.

TABLE 1

| | | Comparative | |
|---|---|---|---|
| | Example 1 | Example 1 | Example 2 |
| Ethylene polymer or | PE-1 | PE-2 | PE-2 80 wt % |
| resin composition | | | PE-3 20 wt % |
| Resin slip velocity | 76 | 26 | 50 |
| at a metal wall | | | |
| (mm/sec.) | | | |
| Mw/Mn | 3.4 | 2.4 | 3.6 |
| MFR (g/10 min.) | 2.2 | 2.0 | — |
| Die lip buildup | Δ | xx | — |
| Die-line | ⊚ | xx | Δ |
| Gel (number/m²) | 74 | 164 | — |

1. An ethylene polymer for cast film processing at a temperature of from about 210 to about 350° C., which polymer has a slip velocity at a metal wall of not less than about 30 mm/sec, wherein the ethylene polymer is obtained by polymerization using a metallocene catalyst for olefin polymerization, and the slip velocity is measured at a temperature of 240° C. and a shear rate of 500 sec⁻¹.

2. The ethylene polymer according to claim 1, wherein the ethylene polymer has a ratio of a weight average molecular weight (Mw) to a number average molecular weight (Mn), Mw/Mn, of not less than about 3.0.

3. A resin composition for cast film processing at a temperature of from about 210 to about 350°C., which composition comprises:
(i) from about 40 to about 90% by weight of an ethylene polymer obtained by polymerization using a metallocene catalyst for olefine polymerization; and
(ii) from about 60 to about 10% by weight of a polyolefine based resin;
and which composition has a slip velocity at a metal wall of not less than about 30 mm/sec;
provided that the sum of the ethylene polymer and the polyolefin based resin is 100% by weight.

4. The resin composition according to claim 3, wherein the resin composition has a ratio of a weight average molecular weight (Mw) to a number average molecular weight (Mn), Mw/Mn, of not less than about 3.0.

5. The resin composition according to claim 3, wherein the resin composition satisfies the following formula (2),
MFR\mathring{2}>4×MF\mathring{1} (2)
wherein MFR \mathring{1} is a melt flow rate of the ethylene polymer, and MFR \mathring{2} is a melt flow rate of the polyolefin based resin.

6. The resin composition according to claim 3, wherein the resin composition satisfies the following formula (3),
MFR\mathring{2}<MFR\mathring{1}/4 (3)
wherein MFR \mathring{1} is a melt flow rate of the ethylene polymer, and MFR \mathring{2} is a melt flow rate of the polyolefin based resin.

7. A process for producing a cast film, which comprises the step of cast film processing, at a temperature of from about 210 to about 350° C., an ethylene polymer having a slip velocity at a metal wall of not less than about 30 mm/sec, wherein the ethylene polymer is obtained by polymerization using a metallocene catalyst for olefin polymerization, and the slip velocity is measured at a temperature of 240° C. and a shear rate of 500 sec⁻¹.

8. The process for producing a cast film according to claim 7, wherein the ethylene polymer has a ratio of a weight average molecular weight (Mw) to a number average molecular weight (Mn), Mw/Mn, of not less than about 3.0.

9. The process for producing a cast film according to claim 7, wherein the cast film obtained has gels of not more than about 140 m² in its number.

10. A process for producing a cast film, which comprises the step of cast film processing, at a temperature of from about 210 to about 350%C, a resin composition having a slip velocity at a metal wall of not less than about 30 mm/sec, wherein the resin composition comprises:
(i) from about 40 to about 90% by weight of an ethylene polymer obtained by polymerization using a metallocene catalyst for olefine polymerization; and
(ii) from about 60 to about 10% by weight of a polyolefine based resin; and
the slip velocity is measured at a temperature of 240° C. and a shear rate of 500 sec⁻¹;
provided that a sum of the ethylene polymer and the polyolefin based resin is 100% by weight.

11. The process for producing a cast film according to claim 10, wherein the resin composition has a ratio of a weight average molecular weight (Mw) to a number average molecular weight (Mn), Mw/Mn, of not less than 3.0.

12. The process for producing a cast film according to claim 10, wherein the resin composition satisfies the following formula (2),
MFR\mathring{2}>4×MFR\mathring{1} (2)
wherein MFR \mathring{1} is a melt flow rate of the ethylene polymer, and MFR \mathring{2} is a melt flow rate of the polyolefin based resin.

13. The process for producing a cast film according to claim 10, wherein the resin composition satisfies the following formula (3),
MFR\mathring{2}<MFR\mathring{1}/4 (3)
wherein MFR \mathring{1} is a melt flow rate of the ethylene polymer, and MFR \mathring{2} is a melt flow rate of the polyolefin based resin.

14. The process for producing a cast film according to claim 10, wherein the cast film obtained has gels of not more than about 140/m² in its number.
